(19) United States
(12) Patent Application Publication
(10) Pub. No.: US 2015/0083458 A1
(43) Pub. Date: Mar. 26, 2015

(54) MULTI-CORE CABLE

(71) Applicant: SUMITOMO ELECTRIC INDUSTRIES, LTD., Osaka-shi, Osaka (JP)

(72) Inventors: Masato Tanaka, Kanuma-shi (JP); Tatsunori Hayashishita, Hachinohe-shi (JP)

(21) Appl. No.: 14/389,434

(22) PCT Filed: Apr. 25, 2013
(86) PCT No.: PCT/JP2013/062231

§ 371 Date: Sep. 30, 2014

(30) Foreign Application Priority Data
May 1, 2012 (JP) 2012-104446

(51) Int. Cl. H01B 7/04; H01B 7/18; H01B 7/30; H01B 7/02

(52) U.S. Cl. CPC H01B 7/04; H01B 7/0241; H01B 7/18; H01B 7/30
USPC 174/107

(57) ABSTRACT

In a multi-core cable 10, plural electric wire units 12 made of stranded plural small-diameter electric wires 11 are bundled to form an electric wire assembly 14 and a shielding layer 15 made of braided a conducting wire 15a is arranged on an outer periphery of the electric wire assembly and an outside of the shielding layer is covered with a sheath 16 made of resin. In the multi-core cable 10, the conducting wire 15a of the shielding layer 15 braided is made of a copper alloy wire given silver plating, and a diameter of the wire of the conducting wire is 0.04 mm to 0.15 mm, and a conductor elongation rate of the conducting wire is 0.8% or more, and a thickness of the silver plating is set at 0.6 μm or more.

### TECHNICAL FIELD

The present invention relates to a multi-core cable for assembling plural small-diameter electric wires used in a medical device, a measuring device, etc.

### BACKGROUND ART

A multi-core cable for bundling plural small-diameter insulated electric wires or coaxial electric wires (hereinafter called small-diameter electric wires) is used for a cable, which is to be twisted and bent, for a measuring device or a medical device of an ultrasonograph etc. This kind of known cable is a multi-core cable in which plural small-diameter electric wires are stranded to form one unit and the plural units are further bundled by a wrapping tape etc. to form an electric wire assembly (also called an assembled core) and an outer periphery of the electric wire assembly is covered with a shielding layer made of braided conductive wires and the outside of the shielding layer is coated with a sheath (for example, see Patent Document 1).

### PRIOR ART DOCUMENT

### Patent Document

Patent Document 1: JP-A-11-329094

### DISCLOSURE OF THE INVENTION

### Problems That the Invention Is to Solve

In the multi-core cable disclosed in Patent Document 1 described above, a metal thin wire is wound on a fiber core to forma shielding strand and the shielding strands are braided to form a shielding layer and thereby, the multi-core cable has high flexibility and good shielding characteristics can be maintained stably for a long time without causing a break in the cable or a fray in the shielding layer due to bends or tension.

However, the multi-core cable disclosed in Patent Document 1 only checks up to bend for 100 turns. Also, in the case of braided normal tin-plated copper alloy strands to form the shielding layer, when the number of bends exceeds 200000, the strands become worn to turn black and become brittle to fracture.

In recent years, good twisting resistance as well as better bending resistance and tensile strength is required for a cable, which is to be twisted and bent, for a measuring device or a medical device of an ultrasonograph etc.

The invention has been implemented in view of the actual circumstances described above, and provides a small-diameter multi-core cable having better twisting resistance and bending resistance.

### SUMMARY OF THE INVENTION

### Means for Solving the Problems

A multi-core cable of the invention capable of solving the problem described above is the multi-core cable in which plural electric wire units made of stranded plural small-diameter electric wires are bundled to form an electric wire assembly and a shielding layer made of braided conducting wires is arranged on an outer periphery of the electric wire assembly and an outside of the shielding layer is covered with a sheath made of resin. The multi-core cable is characterized in that the conducting wire of the braided shielding layer is made of copper alloy wires given silver plating and a diameter of the conducting wire is 0.04 mm to 0.15 mm and a conductor elongation rate of the conducting wire is 0.8% or more and a thickness of the silver plating is 0.6 μm or more.

In the multi-core cable of the invention, the diameter of the conducting wire is preferably 0.08 mm to 0.15 mm.

Also, in the multi-core cable of the invention, a thickness of the sheath is preferably 0.6 mm to 1.0 mm and a distance between the electric wire assembly and an inner surface of the sheath is preferably 0.1 mm to 0.5 mm.

### Advantage of the Invention

The multi-core cable according to the invention described above can withstand more than 550000 twists and bends, and has high long-term reliability, and can better improve noise resistance with respect to shielding characteristics.

### BRIEF DESCRIPTION OF THE DRAWINGS

FIG. 1A is a diagram showing an outline of a multi-core cable according to the invention.

FIG. 1B is a diagram showing a cross section of the multi-core cable.

FIG. 2 is a diagram describing a twisting and bending test method of the multi-core cable.

FIG. 3 is a table showing an evaluation result of the multi-core cable according to the invention.

### DESCRIPTION OF EMBODIMENTS

### Mode for Carrying Out the Invention

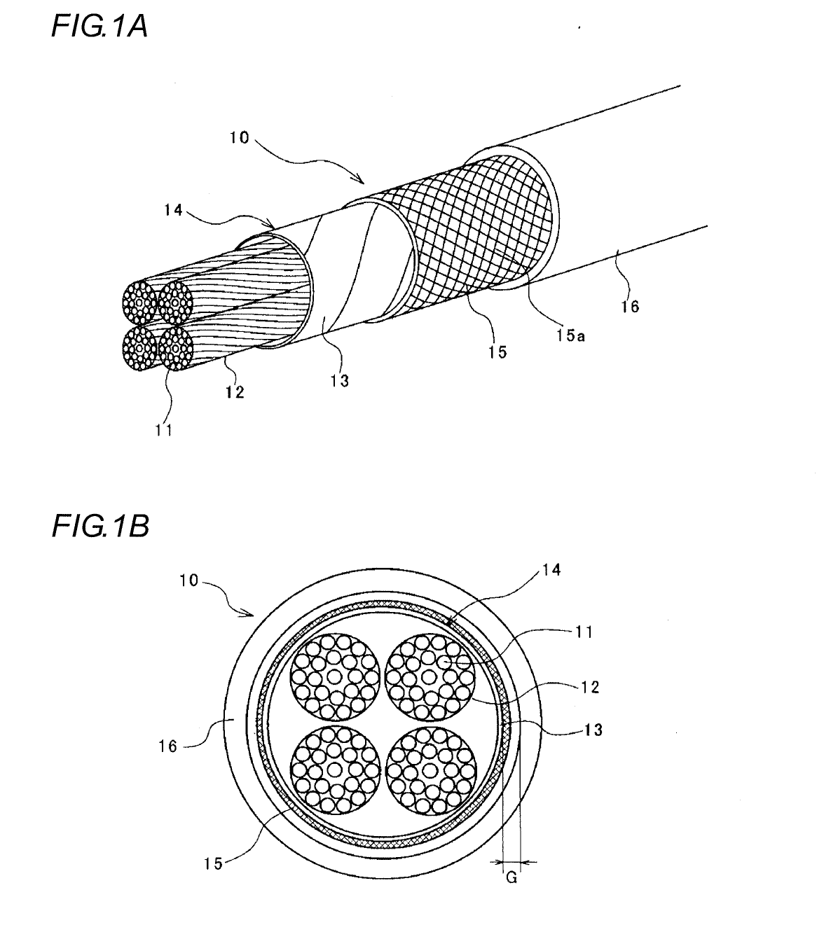

An embodiment of the invention will be described with reference to FIG. 1. A multi-core cable according to the invention is used in, for example, connection of a medical device etc., such as an ultrasonograph etc. FIG. 1A is a diagram showing an outline of the multi-core cable, and FIG. 1B is a diagram showing a cross section of the cable. In FIG. 1, numeral 10 shows a multi-core cable, and numeral 11 shows a small-diameter electric wire, and numeral 12 shows an electric wire unit, and numeral 13 shows a wrapping tape, and numeral 14 shows an electric wire assembly, and numeral 15 shows a shielding layer, and numeral 15a shows a conducting wire, and numeral 16 shows a sheath.

The multi-core cable 10 is constructed by, for example, twisting the plural small-diameter electric wires 11 to form the electric wire unit 12 made of a predetermined number of small-diameter electric wires and further assembling and bundling the plural electric wire units 12 using a wrapping tape 13 etc. to form the electric wire assembly 14 (also called an electric wire core) as shown in FIG. 1A. Then, the shielding layer 15 made of braided conducting wires 15a is arranged on an outer periphery of the electric wire assembly 14 bundled by the wrapping tape 13, and the outside of the shielding layer 15 is covered with the sheath (also called an outer coat) 16 made of resin.

The small-diameter electric wire 11 is made of an insulated electric wire in which a conductor is coated with an insulator or a coaxial electric wire in which the outside of an insulated electric wire is covered with an outer conductor and the outside of the outer conductor is covered with a jacket and, for example, the small-diameter electric wire with an electric wire outside diameter of 0.35 mm or less is used. When the small-diameter electric wire 11 is the insulated electric wire, a conductor with thinner than that of AWG32 is used in a signal conductor, and when the small-diameter electric wire 11 is the coaxial electric wire, a conductor with thinner than that of AWG40 is used in the signal conductor.

The electric wire unit 12 includes one or both of these small-diameter insulated electric wires and coaxial electric wires and is obtained by twisting the plural electric wires.

The plural electric wire units 12 are mutually twisted or not twisted, and are bundled and assembled by being wrapped using the wrapping tape 13 such as a fluorine resin to form the electric wire assembly 14. The shielding layer 15 is arranged on the outer periphery of the electric wire assembly 14, and a noise signal from the outside is prevented from entering the cable and also, a noise signal of the outside is prevented from being diffused from the inside of the cable.

In the invention, the shielding layer 15 described above is formed by braiding the conducting wires 15a in which a copper alloy wire is given silver plating. The braided shielding layer 15 does not include insulating fiber or the like, for example, resin, and is formed of only the conducting wires 15a of the silver-plated copper alloy wires. In addition, the silver plating is softer than the copper alloy wire, and has good lubricity, high-frequency characteristics, low contact resistance, solderability, etc.

The copper alloy wire with a diameter of the wire (diameter of the wire) of about 0.04 mm to 0.15 mm and a conductor elongation rate of 0.8% or more is used as the conducting wire 15a of the shielding layer 15. Then, a surface of its copper alloy wire is given silver plating with a thickness of 0.6 μm or more, and the copper alloy wire is braided at, for example, a braid angle of 65° to 80° to form the shielding layer 15. It is particularly preferable to use the copper alloy wire with the diameter of the wire of 0.08 mm to 0.15 mm as the conducting wire 15a.

The sheath 16 is means for electrically insulating and also mechanically protecting the electric wire assembly 14 on which the shielding layer 15 is arranged. The sheath 16 has a thickness of about 0.6 mm to 1.0 mm, and is formed of a relatively soft resin such as flame-retardant polyethylene or polyvinyl chloride. Also, the sheath 16 can move in a longitudinal direction since the electric wire assembly 14 is relatively loosely covered with the sheath 16. As a result, a gap G between the electric wire assembly 14 and an inner surface of the sheath 16 is preferably set at 0.1 mm to 0.5 mm on average.

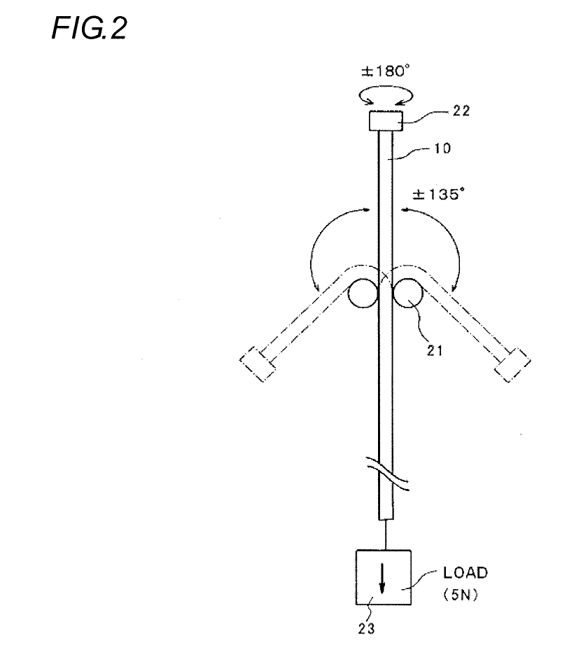

In the multi-core cable 10 constructed as described above, as shown by an evaluation result described below, even when the number of twists and bends exceeds 550000 in a twisting and bending test shown in FIG. 2, shielding characteristics are well maintained without causing a break in the cable or a fray, and long-term reliability is high.

FIG. 2 is a diagram showing a twisting test method of the multi-core cable described above, and a multi-core cable 10′ for test with a predetermined length was inserted between a pair of mandrels 21, and the upper end of the multi-core cable 10′ was gripped by a chuck 22 and the lower end of the multi-core cable 10′ was drooped by a weight 23 with a load of 5 N. Then, the multi-core cable 10′ was bent ±135° like a pendulum to both sides of the pair of mandrels 21 while twisting the chuck 22 ±180° around the axis of the multi-core cable 10′. It was tested whether or not a fray or a break in the cable was caused in a shielding layer of the multi-core cable 10 as a result of performing the twists and bends with frequency 10 times per minute.

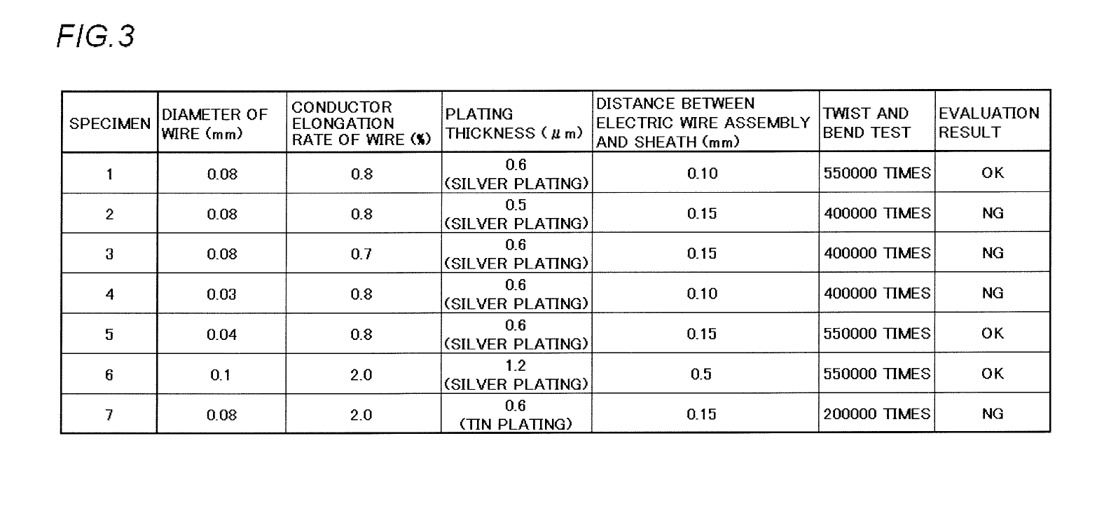

FIG. 3 is a table showing a test result of the multi-core cable by the twisting test described above. In addition, for specimens 1 to 6, a conducting wire of a shielding layer was a silver-plated copper alloy wire and for specimen 7, the conducting wire was a tin-plated copper alloy wire. Also, a diameter of the wire of the conducting wire of the braided shielding layer of the multi-core cable tested was set at 0.08 mm for specimens 1 to 3 and 7, and was set at 0.03 mm for specimen 4, and was set at 0.04 mm for specimen 5, and was set at 0.1 mm for specimen 6. A conductor elongation rate of the conducting wire was set at 0.8% for specimens 1, 2, 4 and 5, and was set at 0.7% for specimen 3, and was set at 2.0% for specimens 6 and 7. A thickness of plating which the conducting wire was given was set at 0.6 μm for specimens 1, 3 to 5 and 7, and was set at 0.5 μm for specimen 2, and was set at 1.2 μm for specimen 6. Also, a distance between the electric wire assembly and an inner surface of the sheath was set at 0.1 mm to 0.5 mm as described in FIG. 3.

As the above result, 550000 twists and bends can be cleared for specimens 1, 5 and 6, but 400000 twists and bends cannot be cleared for specimens 2 to 4, and 200000 twists and bends cannot be cleared for specimen 7.

And, the diameter of the wire of the conducting wire of the braided shielding layer is preferably smaller from the standpoint of reduction in diameter of the cable, but the evaluation result of specimens 4 and 5 described above shows that the diameter of the wire is desirably 0.04 mm or more. When an outside diameter of the cable is too large, handling is not good. In this respect, an outside diameter of the conducting wire of the shielding layer is also limited to a certain level of size, and is preferably 0.15 mm or less. The test result of specimens 1 and 3 shows that the conductor elongation rate of the conducting wire is desirably 0.8% or more and has no upper limit in respect of durability, and the conductor elongation rate is determined by balance of conductivity.

Also, from the evaluation result of specimens 1 and 2, the thickness of silver plating of the conducting wire is desirably 0.6 μm or more and has no upper limit from the result of specimen 6, but the sufficient thickness is probably substantially 2 μm or less.

Also, the electric wire assembly is loosely covered with the sheath and in order to prevent the conducting wire of the shielding layer from fraying or being broken due to twists and bends of the cable, the distance between the electric wire assembly and the inner surface of the sheath is preferably 0.1 mm or more. However, the distance is desirably set at 0.5 mm or less from the standpoint of reduction in diameter of the cable.

The present application is based on Japanese patent application (patent application No. 2012-104446) filed on May 1, 2012, and the contents of the patent application are hereby incorporated by reference.

1. A multi-core cable in which plural electric wire units made of stranded plural small-diameter electric wires are bundled to form an electric wire assembly and a shielding layer made of braided conducting wires is arranged on an outer periphery of said electric wire assembly and an outside of the braided shielding layer is covered with a sheath made of resin,
wherein the conducting wire of the shielding layer braided is made of copper alloy wires given silver plating and a diameter of the conducting wire is 0.04 mm to 0.15 mm and a conductor elongation rate of the conducting wire is 0.8% or more and a thickness of the silver plating is 0.6 μm or more.

2. A multi-core cable according to claim 1, wherein the diameter of the conducting wire is 0.08 mm to 0.15 mm.

3. A multi-core cable according to claim 1, wherein a thickness of the sheath is 0.6 mm to 1.0 mm and a distance between the electric wire assembly and an inner surface of the sheath is 0.1 mm to 0.5 mm.

4. A multi-core cable according to claim 2, wherein a thickness of the sheath is 0.6 mm to 1.0 mm and a distance between the electric wire assembly and an inner surface of the sheath is 0.1 mm to 0.5 mm.
